(19) United States
(12) Patent Application Publication
(10) Pub. No.: US 2025/0363547 A1
(43) Pub. Date: Nov. 27, 2025

(54) DETECTING USER ACTIONS BASED ON SMART CART SENSOR DATA

(71) Applicant: Maplebear Inc., San Francisco, CA (US)

(72) Inventors: David McIntosh, San Francisco, CA (US); Dominic Cocchiarella, Berkeley, CA (US); Anirban Kundu, Danville, CA (US)

(21) Appl. No.: 19/217,918

(22) Filed: May 23, 2025

Related U.S. Application Data
(60) Provisional application No. 63/651,314, filed on May 23, 2024.
(60) Provisional application No. 63/651,836, filed on May 24, 2024.

(51) Int. Cl. G06Q 30/0601; G06Q 30/0201

(52) U.S. Cl. CPC G06Q 30/0633; G06Q 30/0201

(57) ABSTRACT

A system causes a display screen to present a set of content for a first time period. The system accesses a first set of location data captured by location sensors coupled to shopping carts. The first set of location data indicates a location of each of a plurality of users of the shopping carts]. The system identifies a set of users within a distal proximity of the display screen during the first time period. The system accesses sensor data captured by sensors of the shopping carts and detects an action performed by a first user in relation to a first item. The system identifies a timestamp for the action. In response to the timestamp being within a threshold amount of time after the first time period, the system stores proximity data indicative of an interaction with the set of content in association with the first user.

### CROSS-REFERENCE TO RELATED APPLICATIONS

This application claims the benefit of U.S. Provisional Patent Applications Nos. 63/651,314, filed May 23, 2024, and 63/651,836, filed May 24, 2024, each of which is incorporated by reference in its entirety.

### BACKGROUND

Conventional systems establish causality between real-world events based predominantly on data collected from a single device. For instance, a system may engage with numerous devices within a setting that gather sensory data about said environment. The system then determines whether one or more events have happened based on the obtained data but limits its analysis to each device independently, solely correlating events associated with the individual device. The system cannot model real-world events without collecting data about the events that occurred throughout the environment, without supplementary data input concerning the occurrence of an event at a given device, the system is limited to a narrow perspective on the events that transpired within the environment.

Conventional systems that are capable of discerning the occurrence of events using varying data sources encounter limitations associated with linking and unifying data for the assignment and identification of distinct events. For instance, in an online environment, various events transpiring across different websites can be conveniently reconciled given the shared device context. Conversely, for a network of interconnected devices, systems encounter difficulties when correlating events observed at user-associated devices and those captured at devices providing and encapsulating information about the users' general environment. This dichotomy between personalized and environmental data poses a significant challenge for establishing cross-device causality correlations.

While this process may be effective at determining user preferences in a context where the user is interacting with content by directly interacting with a computing device, it fails to capture indirect user interactions with content in the physical world. For example, this approach would be ineffective at identifying user interactions with content where the content is presented through display screens in a physical environment. These display screens may dynamically change the content they present based on instructions from a remote system or based on computer-executable instructions stored on a storage medium of the screen. However, these display screens generally do not have capabilities for detecting user interactions, which generally prevents computing systems from correlating user real-world actions to presented content.

### SUMMARY

In accordance with one or more aspects of the disclosure, a system contextualizes sensor data captured by smart shopping carts with interaction data and uses the contextualized data to present content. More particularly, an environment of items may include screens that display content about one or more items to users traversing the environment. A system that communicates with smart shopping carts may access locations of the smart shopping carts in the environment and may identify users associated with the shopping carts that are within a threshold area of one of the screens. The system determines whether one of the users takes an action with one of the items based on sensor data accessed from the user's smart shopping cart and stores proximity data indicative of an interaction with the content displayed about the one or more items.

In accordance with one or more embodiments, the system causes a display screen in an environment to present a set of content related to one or more items located in the environment. The display screen presents the set of content for a first time period. The system accesses a first set of location data captured by location sensors coupled to one or more shopping carts. The first set of location data indicates a location of each of a plurality of users of the shopping carts in the environment. The system identifies, based on the first set of location data, a set of users within a distal proximity of the display screen in the environment during the first time period. The system accesses sensor data captured by sensors coupled to the one or shopping carts and detects an action performed by a first user of the set of users based on the accessed sensor data, where the action was performed in relation to a first item of the one or more items. The system identifies a timestamp for the detected action based on the accessed sensor data and determines whether the timestamp is within a threshold amount of time after the first time period. In response to the timestamp being within the threshold amount of time after the first time period, the system stores proximity data indicative of an interaction with the set of content presented by the display in association with the first user. The system causes a second set of content to display to the user based on the proximity data stored in relation to the user.

By leveraging location data captured by sensors of a smart shopping cart, the system improves on the technical field of generating computer models of real-world activities. In particular, the location data captured by smart shopping carts provides otherwise unavailable information about user locations within an environment, which enables the system to correlate real-world events that would be otherwise unavailable for correlation.

### BRIEF DESCRIPTION OF DRAWINGS

FIG. 1 illustrates an example environment of a smart cart system, in accordance with one or more illustrative embodiments.

FIG. 2 is a block diagram illustrating components of a remote system, in accordance with one or more embodiments.

FIG. 3 is a block diagram illustrating a display in an item storage environment, in accordance with one or more illustrative embodiments.

FIG. 4 is a flowchart illustrating a method for causing a device to display content to a user, in accordance with one or more embodiments.

### DETAILED DESCRIPTION

### Example System Environment for Smart Cart System

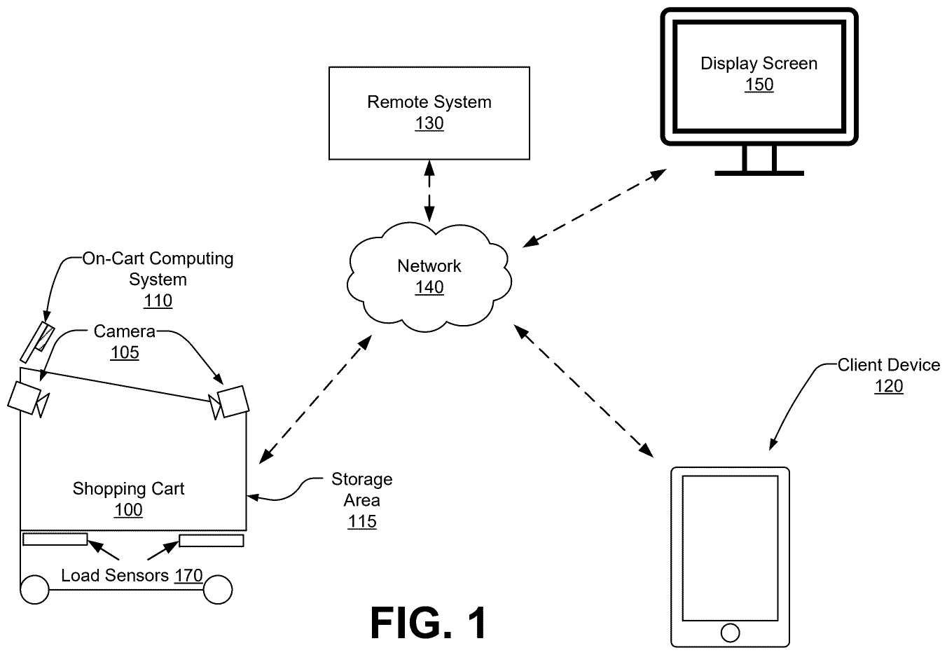

FIG. 1 illustrates an example system environment for a smart cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves—the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 can communicate with the display screen 150 via the network 140. Though only one display screen 150 is shown in FIG. 1, in some embodiments, the system environment includes additional display screens 150. The display screen 150 may present a variety of content, including textual and image-based content. The display screen 150 may also output audio content. The display screen 150 may dynamically update the content it presents based on instructions received from the remote system 130 via the network 140. The display screen 150 may access content stored at the remote system 130 or at the display screen 150 itself. The display screen 150 may include a processor and a non-transitory computer-readable medium that stores instructions that may be executed by the processor. The display screen 150 also may include a touch screen display, a speaker, a microphone, a keypad, etc. The display screen 150 may also include a wireless network adapter that allows the display screen 150 to communicate via the network 140.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charge the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information. In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

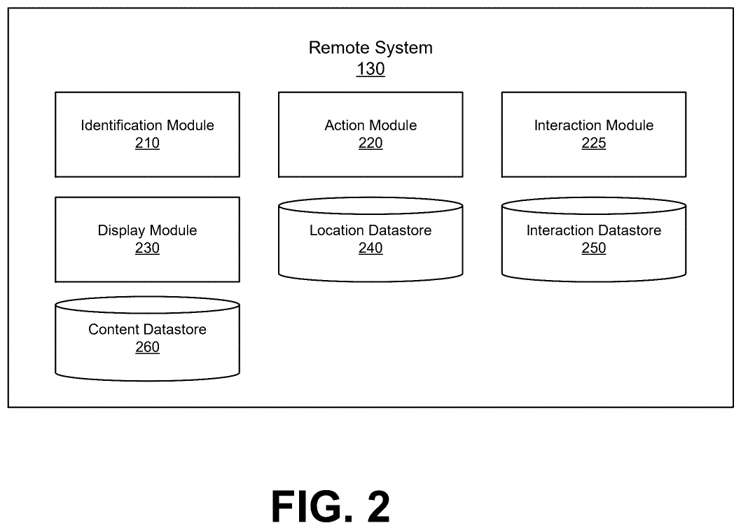

FIG. 2 is a block diagram illustrating components of a remote system, in accordance with one or more embodiments. The remote system 130 includes an identification module 210, an action module 220, a display module 230, a location datastore 240, an interaction datastore 250, and a content datastore 260. In some embodiments, remote system 130 includes additional or alternative components to those shown in FIG. 2. As noted above, while FIG. 2 describes functionality performed by a remote system, some or all of the described functionality may be performed by a shopping cart 100 or a client device, individually or in combination with the remote system.

The identification module 210 identifies users that are within threshold areas associated with display screens of an environment. The identification module 210 accesses location data captured by location sensors at shopping carts 100 in the environment. The identification module 210 may also access location data for one or more client devices 102 in the environment. However, for simplicity, the following is described in relation to shopping carts 100. The identification module 210 may request the location data from a shopping cart 100 or may receive the sensor data from a shopping cart 100. The location data of a shopping cart 100 may include a set of locations each associated with a timestamp representing a time that the shopping cart 100 was at the location. In some embodiments, the identification module 210 receives image data captured at a shopping cart 100, and the identification module 210 detects a location of the shopping cart 100 when each image was taken based on identifying features of the environment around the shopping cart 100.

The location of a shopping cart 100 may serve as a proxy for a location of a user of the shopping cart 100. For each shopping cart, the identification module 210 accessed location data for, the identification module 210 may identify a user associated with (e.g., using) the shopping cart 100. In some embodiments, the location data accessed for a shopping cart 100 may include an identifier of the user, which the user may have entered at the shopping cart 100 or the shopping cart 100 may have accessed the identifier of the user from a client device 120 located within a threshold vicinity of the shopping cart 100. For each location of a shopping cart 100 described by the location data, the identification module 210 stores the location with a location timestamp representing a time the shopping cart 100 was at the location and an identifier of a respective user in the location datastore 240.

The identification module 210 accesses a map of the environment from the location datastore. The map includes locations of displays screens in the environment. The display screens are configured to present content based on communications received from the display module 230. The map also includes a threshold area associated with each display screen. Each threshold area represents a physical area around or near the associated display screen. For each threshold area, the identification module 210 identifies any shopping carts 100 with location data that indicate the shopping cart 100 was within the threshold area. The identification module 210 identifies a location timestamp associated with each instance of a shopping cart 100 being located within the threshold area and stores the location timestamp and identifier of a user of the shopping cart 100 in association with the threshold area in the location datastore 240.

The action module 220 detects interactions by users with content presented via the display screens in the environment. The action module 220 accesses sensor data captured by the sensors in the environment. The sensors may be coupled to shopping carts 100 and client devices 120 in the environment or may be at fixed locations within the environment. The action module 220 may receive the sensor data from the shopping carts 100 and client devices 120 as the sensor data is captured in real-time. The sensor data may include images of the environment, RFID tag data indicating movement of items in the environment, and load sensor data indicative of weight added into shopping cart baskets.

The action module 220 may use the sensor data to detect whether a user interacted with one or more items in the environment. For example, the action module 220 may apply one or more computer vision techniques to the images to detect a user interacting with an item, such as picking up the item, putting the item in their shopping cart 100, taking a picture of the item, etc. In another example, the action module 220 may identify an item moved into the shopping cart 100 based on detecting an RFID tag of the item in the shopping cart and load sensor data indicating weight has been added to the basket of the shopping cart 100. The action module 220 identifies one or more action timestamps associated with each action and an identifier of a user who performed the action, which the action module 220 may do using facial recognition techniques, a stored association with the identifier of the user and a shopping cart captured in or depicted by the sensor data, and the like. The action module 220 stores the action with the one or more action timestamps in association with the identifier of the user in the interaction datastore 250. The action may be stored as an indication of a generic interaction with an item or a type of action (e.g., picking, viewing, etc.) performed with the item.

The interaction module 225 associates actions performed by users with content presented via one or more display screens in the environment. The interaction module 225 may identify the associations periodically, when new actions are detected and stored in the interaction datastore 250 by action module 220, and upon request from an external operator. The interaction module 225 accesses location timestamps representing times when users were within a threshold area of a display screen from the location datastore 240. Each location timestamp is associated with a threshold area and an identifier of a user who was located within the threshold area at the time of the timestamp. For each location timestamp, the interaction module 225 accesses the content datastore 206 to retrieve a set of content that was presented at the display screen of the threshold area at a time of the timestamp. The set of content may also be associated with a time period of presentation at the display screen. The interaction module 225 accesses the interaction datastore 250 to retrieve actions associated with the identifier of the user.

For each retrieved action, the interaction module 225 determines whether the action was performed in relation to one or more items described in the set of content. In response to determining that the action was performed in relation to at least one of the items described in the set of content, the interaction module 225 determines whether an action timestamp associated with the action is within a threshold amount of time after the time period during which the set of content was presented. The threshold amount of time may be set by an external operator or may be a length of time the user was continuously in the environment. In response to the action timestamp being within the threshold amount of time after the first time period, the interaction module 225 stores proximity data indicative of an interaction by the user with the set of content presented by the display screen. The interaction module 225 may store the proximity data in the interaction datastore 250. The proximity data may include the action, the one or more items described by the set of content, the set of content itself, the action timestamp, an identifier of the display screen that the presented the set of content, a distance between the user and the display screen, and the like. In some embodiments, the proximity data includes a linked list for each item in the environment. The linked list may include a first link between a first set of content describing the item presented prior to an action that was performed by the user and the action and a second link between the action and a second set of content describing the item presented after the action occurred. The interaction datastore 250 may update the linked list to include subsequent actions the user takes in relation to the item and sets of content presented to the user about the item when the user is within a threshold area of a display screen that is presenting a respective set of content.

The display module 230 causes sets of content to be presented to users. The display module 230 may receive a request for a set of content to display at a display screen periodically or in response to an input from an external operator. The request may include one or more items to present content about, and the display module 230 may access sets of content describing the one or more items stored in the content datastore 260. In some embodiments, the request indicates to present a set of content to a particular user. The display module 230 may access proximity data associated with an identifier of the user in the interaction datastore 250. The display module 230 creates a prompt including the proximity data and the request for the set of content to present to the user, which may include one or more items. The display module 230 inputs the prompt to a generative language model that is tuned on proximity data of users who have traversed the environment. The display module 230 may receive a set of content from the generative language model and select one or more display screens to present the set of content to the user. In some embodiments, the display module 230 may select a display screen closest to a current location of the user, a display screen affixed to the user's shopping cart 100, or a display screen of the user's client device 120. The display module 230 causes the one or more display screens to present the set of content and stores an indication of presentation of the set of content at the display screen the content datastore, along with a time period the set of content is presented for.

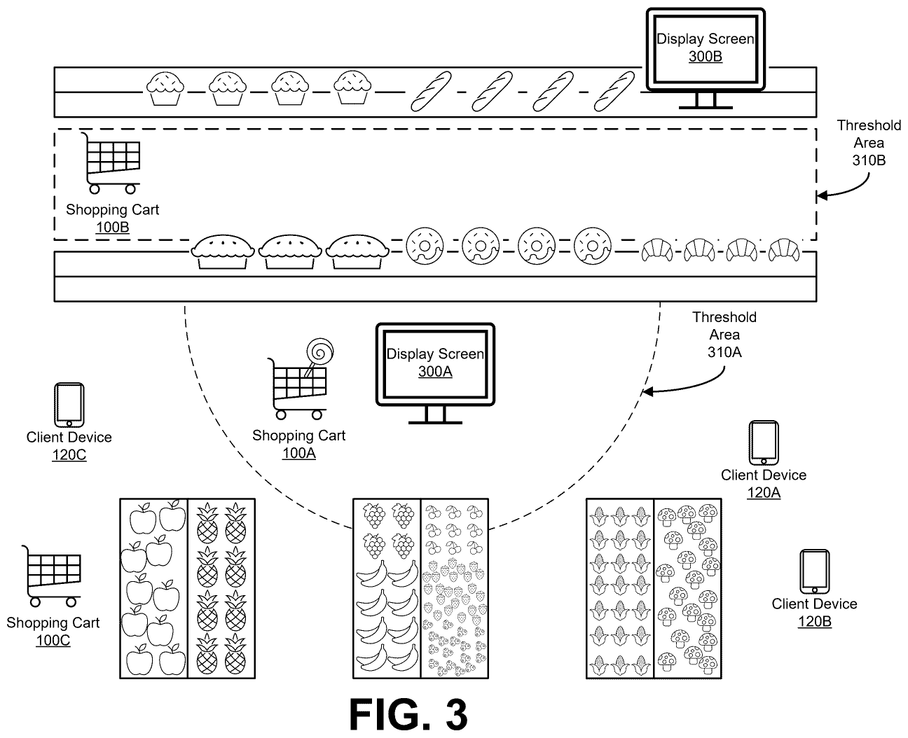

FIG. 3 is a block diagram illustrating a display screen 300A in an item storage environment, in accordance with one or more illustrative embodiments. The item storage environment includes an arrangement of items and display screens 300 (or 150) and a few shopping carts 100 and client devices 120 that are each representative of a location of a user in the item storage environment. Each display screen 300 is associated with a threshold area in the environment. The threshold areas may be any geometric shape. In FIG. 3, threshold area 310A is a semi-circle that encompasses the location of display screen 300A and extends into a produce section but does not extend into an aisle of baked goods. Threshold area 310B is a rectangle that covers the area within the aisle of baked goods.

Shopping cart 100A is located within threshold area 310A, and location data representing this positioning of shopping cart 100A may be sent to remote system 130, which stores a location timestamp of shopping cart 100A being at the location. Remote system 130 may also store an indication of a set of content that is being presented at display screen 300A and a time period for which the set of content is displayed for. As the shopping cart 100A moves in that environment, the remote system 130 may track whether the user of shopping cart 100A takes any actions with items in the item storage environment. For a detected action with an item, remote system 130 identifies an action timestamp for the action indicative of a time the action occurred and determines whether the action timestamp is within the time period of presentation of the set of content at display screen 300A. Remote system 130 also determines whether the user was within threshold area 310A within the time period associated with the set of content and whether the item is described by the set of content. In response to the timestamp being within the threshold amount of time after the first time period, the user being within the threshold area during the time period, and the item being described by the set of content, remote system 130 stores proximity data indicative of an interaction by the user with the set of content presented by display screen 300A. Remote system 130 may use this proximity data to identify sets of content to present to the user later, such as when shopping cart 100A is within threshold area 310A of display screen 300B.

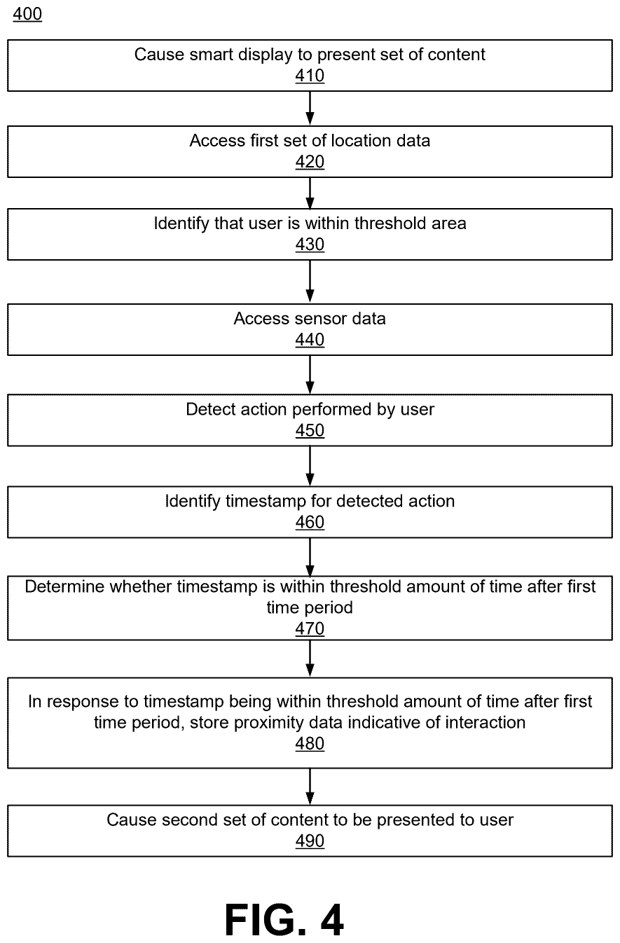

FIG. 4 is a flowchart illustrating a method 400 for causing a device to display content to a user, in accordance with one or more embodiments. In some embodiments, additional or alternative steps or components to those described in relation to FIG. 4 may be used for the method 400.

The method 400 begins with the display module 230 causing 410 a smart display (e.g., a display screen 300) in an environment to present a set of content related to one or more items located in the environment. The smart display presents the set of content for a first time period. The identification module accesses 420 a first set of location data captured by location sensors coupled to one or more shopping carts in the environment, where the first set of location data indicates a location of a user of a shopping cart. The identification module 210 identifies 430 that the user is within a threshold area of the smart display in the environment during the first time period based on the first set of location data.

The action module 220 accesses 440 sensor data captured by sensors coupled to the one or shopping carts and detects 450 an action performed by the user based on the accessed sensor data, where the action is performed in relation to a first item of the one or more items. The action module 220 identifies 460 a timestamp for the detected action based on the accessed sensor data. The interaction module 225 determines 470 whether the timestamp is within a threshold amount of time after the first time period. In response to the timestamp being within the threshold amount of time after the first time period, the interaction module 225 stores 480 proximity data indicative of an interaction with the set of content in association with the user. The display module 230 causes 490 a second set of content to be presented to the user based on the proximity data stored in relation to the user. In some embodiments, the interaction module 225 uses the proximity data stored in relation to the user for attributions or analytics regarding the user, such that the interaction module 225 may use the attributions or analytics to cause actions to occur in the environment or content to be displayed to the user, among other uses,

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
causing a smart display in an environment to present a set of content related to one or more items located in the environment, wherein the smart display presents the set of content for a first time period;
accessing a first set of location data captured by location sensors coupled to one or more shopping carts, the first set of location data indicating a location of a user of a shopping cart in the environment;
identifying, based on the first set of location data, that the user is within a threshold area of the smart display in the environment during the first time period;
accessing sensor data captured by sensors coupled to the one or shopping carts;
detecting an action performed by the user based on the accessed sensor data, the action being performed in relation to a first item of the one or more items;
identifying a timestamp for the detected action based on the accessed sensor data;
identifying whether the timestamp is within a threshold amount of time after the first time period;
in response to the timestamp being within the threshold amount of time after the first time period, storing, in association with the user, proximity data indicative of an interaction with the set of content presented by the smart display; and
causing a second set of content to be presented to the user based on the proximity data stored in relation to the user.

2. The method of claim 1, wherein storing, in association with the user, proximity data indicative of an interaction with the set of content presented by the smart display comprises:
storing, in association with the user, the proximity data in a first linked list associated with the first item, wherein the first linked list includes a plurality of sets of proximity data and a plurality of sets of content.

3. The method of claim 2, wherein each set of proximity data is associated with a first set of content presented prior to an interaction of the proximity data and a second set of content presented after an interaction of the proximity data and each set of content is associated with a first set of proximity data including a first interaction with the item that occurred before presentation of the set of content and a second set of proximity data including a second interaction with the item that occurred after presentation of the set of content.

4. The method of claim 2, further comprising:
creating a first prompt including the proximity data and a first request for the second set of content to present to the user;
inputting the first prompt to a first generative language model, the first generative language model tuned on a set of linked lists, wherein the set of linked lists includes the first linked list and each linked list is associated with one of the one or more items in the environment; and
receiving, as output from the first generative language model, the second set of content.

5. The method of claim 1, further comprising:
causing a second smart display to present the second set of content, wherein the second smart display is affixed to the shopping cart associated with the user.

6. The method of claim 1, further comprising:
causing a second smart display to present the second set of content, wherein the second smart display is at a client device associated with the user.

7. The method of claim 1, wherein the proximity data associated with the user is further indicative of a distance between the user's shopping cart and the smart display.

8. The method of claim 1, wherein the proximity data includes the first time, a second time, and the action.

9. The method of claim 1, wherein the action is one of viewing the first item, picking up the first item, or putting the first item in the user's shopping cart.

10. A non-transitory computer-readable storage medium storing instructions that, when executed, cause a processor to perform steps comprising:
causing a smart display in an environment to present a set of content related to one or more items located in the environment, wherein the smart display presents the set of content for a first time period;
accessing a first set of location data captured by location sensors coupled to one or more shopping carts, the first set of location data indicating a location of a user of a shopping cart in the environment;
identifying, based on the first set of location data, that the user is within a threshold area of the smart display in the environment during the first time period;
accessing sensor data captured by sensors coupled to the one or shopping carts;
detecting an action performed by the user based on the accessed sensor data, the action being performed in relation to a first item of the one or more items;
identifying a timestamp for the detected action based on the accessed sensor data;
identifying whether the timestamp is within a threshold amount of time after the first time period;
in response to the timestamp being within the threshold amount of time after the first time period, storing, in association with the user, proximity data indicative of an interaction with the set of content presented by the smart display; and
causing a second set of content to be presented to the user based on the proximity data stored in relation to the user.

11. The non-transitory computer-readable storage medium of claim 10, wherein storing, in association with the first user, proximity data indicative of an interaction with the set of content presented by the smart display comprises:
storing, in association with the user, the proximity data in a first linked list associated with the first item, wherein the first linked list includes a plurality of sets of proximity data and a plurality of sets of content.

12. The non-transitory computer-readable storage medium of claim 11, wherein each set of proximity data is associated with a first set of content presented prior to an interaction of the proximity data and a second set of content presented after an interaction of the proximity data and each set of content is associated with a first set of proximity data including a first interaction with the item that occurred before presentation of the set of content and a second set of proximity data including a second interaction with the item that occurred after presentation of the set of content.

13. The non-transitory computer-readable storage medium of claim 11, the steps further comprising:
creating a first prompt including the proximity data and a first request for the second set of content to present to the user;
inputting the first prompt to a first generative language model, the generative language model tuned on a set of linked lists, wherein the set of linked lists includes the first linked list and each linked list is associated with one of the one or more items in the environment; and
receiving, as output from the first generative language model, the second set of content.

14. The non-transitory computer-readable storage medium of claim 10, the steps further comprising:
causing a second smart display to present the second set of content, wherein the second smart display is affixed to the shopping cart associated with the user.

15. The non-transitory computer-readable storage medium of claim 10, the steps further comprising:
causing a second smart display to present the second set of content, wherein the second smart display is at a client device associated with the user.

16. The non-transitory computer-readable storage medium of claim 10, wherein the proximity data associated with the user is further indicative of a distance between the user's shopping cart and the smart display.

17. The non-transitory computer-readable storage medium of claim 10, wherein the proximity data includes the first time, a second time, and the action.

18. The non-transitory computer-readable storage medium of claim 10, wherein the action is one of viewing the first item, picking up the first item, or putting the first item in the user's shopping cart.

19. A system comprising:
a processor; and
a non-transitory computer-readable storage medium storing instructions that, when executed, cause the processor to perform steps comprising:
causing a smart display in an environment to present a set of content related to one or more items located in the environment, wherein the smart display presents the set of content for a first time period;
accessing a first set of location data captured by location sensors coupled to one or more shopping carts, the first set of location data indicating a location of a user of a shopping cart in the environment;
identifying, based on the first set of location data, that the user is within a threshold area of the smart display in the environment during the first time period;
accessing sensor data captured by sensors coupled to the one or shopping carts;
detecting an action performed by the user based on the accessed sensor data, the action being performed in relation to a first item of the one or more items;
identifying a timestamp for the detected action based on the accessed sensor data;
identifying whether the timestamp is within a threshold amount of time after the first time period;
in response to the timestamp being within the threshold amount of time after the first time period, storing, in association with the user, proximity data indicative of an interaction with the set of content presented by the smart display; and
causing a second set of content to be presented to the user based on the proximity data stored in relation to the user.

20. The system of claim 19, wherein storing, in association with the first user, proximity data indicative of an interaction with the set of content presented by the smart display comprises:
storing, in association with the user, the proximity data in a first linked list associated with the first item, wherein the first linked list includes a plurality of sets of proximity data and a plurality of sets of content.
